(19) United States
(12) Patent Application Publication
(10) Pub. No.: US 2011/0185923 A1
(43) Pub. Date: Aug. 4, 2011

(54) Roller press for paper arts

(76) Inventor: Chia-Shun Lee, Taoyuan County (TW)

(21) Appl. No.: 12/926,750

(22) Filed: Dec. 8, 2010

(30) Foreign Application Priority Data
Jan. 29, 2010 (TW) 099201937

(51) Int. Cl. B30B 3/04

(52) U.S. Cl. 100/176

(57) ABSTRACT

A roller press includes two rollers each having a first end extending through a first sidewall of a roller unit frame so as to be connected with a gear unit which is cooperated with an operation handle, and two respective second ends of the two rollers extend through a second sidewall of the roller unit frame so as to form an open-type entry. A close-type entry is defined between the two rollers located between the first and second sidewalls of the roller unit frame. The two entries are able to press the paper products of different widths.

### BACKGROUND OF THE INVENTION

(1) Field of the Invention

The present invention relates to a roller press, and more particularly, to a roller press for paper arts and includes two rollers to from an open path and a closed path.

(2) Description of the Prior Art

A conventional roller press for paper arts generally includes a frame with two sidewalls and the roller unit is connected between the two sidewalls so as to define an entry for the paper products to be rolled by the roller unit. Because the two sidewalls for positioning the roller unit, the width of the entry is fixed and only the paper products that has the width within the acceptable width of the entry can be rolled by the roller unit. When the width of the paper product is too wide to be inserted into the entry, a larger roller press is needed. Even if only a part of the paper product is needed to be rolled, the larger roller press is required.

Not only the width of the roller unit is the problem that the users may face, the longer the roller unit is, the larger force is needed, so that for some users, the larger roller press is difficult to operate.

In addition, the conventional paper punch has fixed number of punch heads for punching the fixed numbered of holes. Therefore, multiple paper punches are needed in the office, such as the paper punches to make two holes, three holes, six holes, twenty holes, twenty six holes or even thirty holes.

The decoration to edges of paper products can be made by hands such as using scissors and the edges are glued head-to-tail to form a long decorated edge.

The conventional C-type roller press lacks a positioning end so that the paper products are easily deformed so that it is not suitable for precise rolling processes such as the relief model.

U.S. Pat. No. 7,335,009 discloses a roller press which has the active gear unit and passive gear unit located on two ends of the roller frame so that the users can use less force to operate the roller press. Nevertheless, along with the increased thickness and area of the paper products, the users still have to apply significant force to operate the roller press. Especially when the width of the paper products is wider than the width of the entry of the roller press, a larger roller press is needed.

The present invention intends to provide a roller press which has multiple functions and requires less force to operate.

### SUMMARY OF THE INVENTION

The present invention relates to a roller press and comprises two rollers and two respective first ends of the two rollers extend through a first sidewall of a roller unit frame and are connected with a gear unit on outside of the first sidewall. Two respective second ends of the two rollers extend through a second sidewall of the roller unit frame. A gap is defined between the two rollers to form a dual-roller pressing mechanism. An operation handle has a crank which extends through a first crank bearing, a second crank bearing and a shaft with a start pinion connected thereto. A case is mounted to the dual-roller mechanism and two entries are defined in a front side and a rear side of the case. The two entries are located corresponding to the gap. The two entries define a first path and a second path located at a distance from the gap. A base is located beneath the dual-roller mechanism and fixed to the case. Two bridges are located on the front side and the rear side of the case and located corresponding to the two entries.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the front view of the roller press of the present invention;

FIG. 2 is a perspective view to show the roller press of the present invention;

FIG. 3 is another perspective view to show the roller press of the present invention;

FIG. 4 is a perspective view to show the roller press of the present invention, wherein case, the base and the two bridges are assembled thereto;

FIG. 5 is a front view of the roller press in FIG. 4, and

FIG. 6 shows the folded status of the roller press of the present invention.

### DETAILED DESCRIPTION OF THE PREFERRED EMBODIMENT

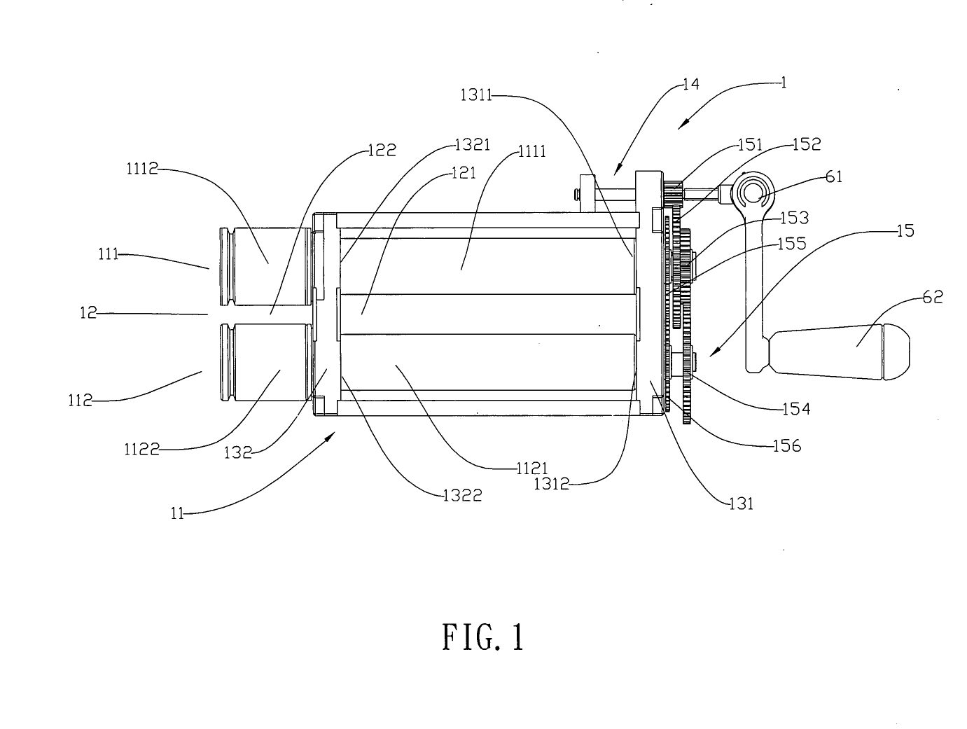

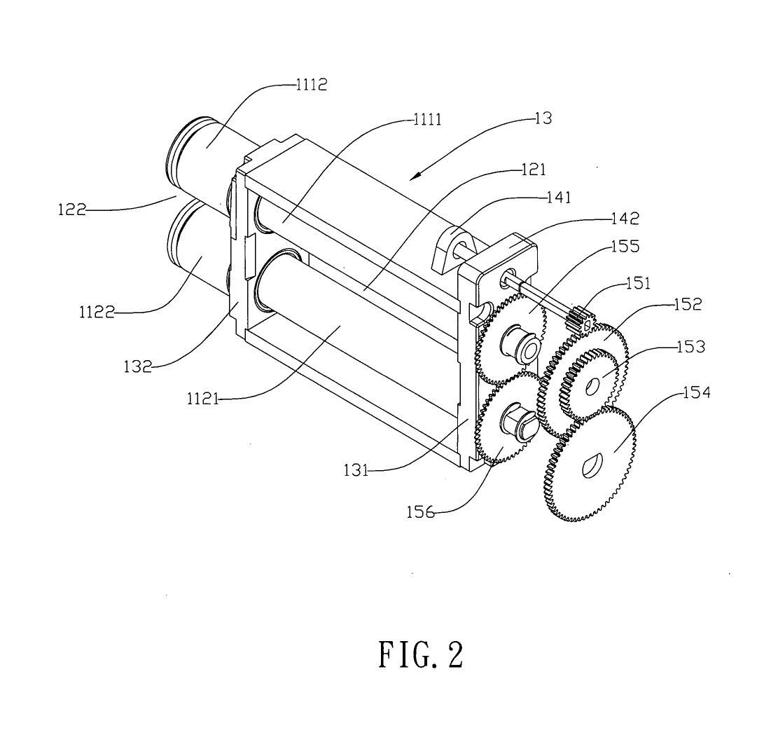

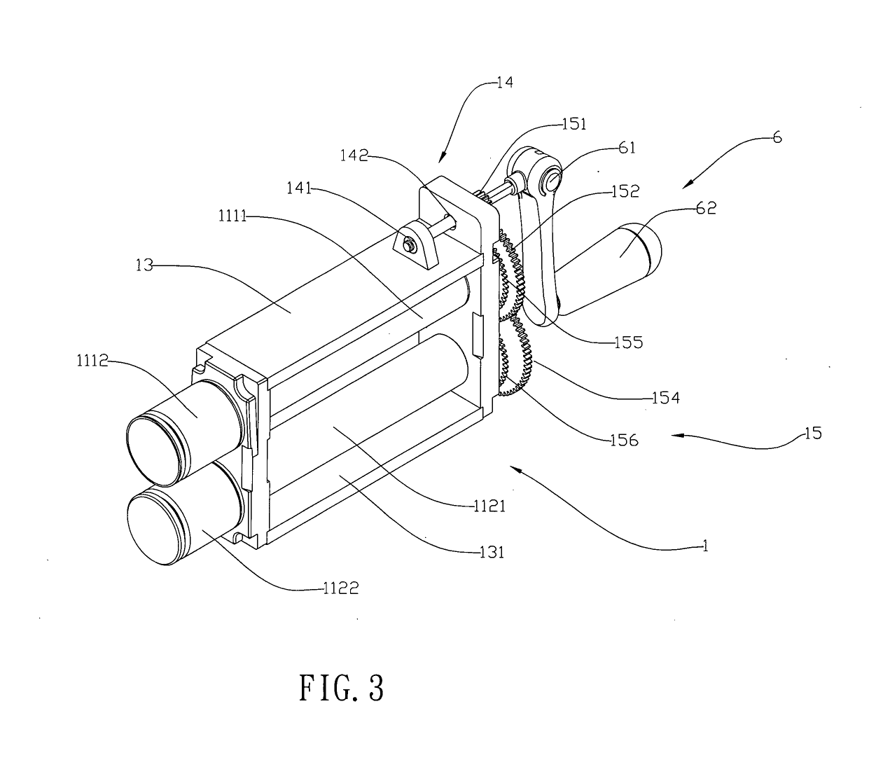

Referring to FIGS. 1 to 4, the roller press of the present invention comprises a roller unit 11, a mold entry 12, a roller unit frame 13, a crank positioning frame 14, a gear unit 15 and an operation handle 16. The operation handle 6 has a crank 62 which extends through a first crank bearing 141, a second crank bearing 142, a shaft 61 and a crank 62, wherein a start pinion 151 is connected to the shaft 61 so that the operation of the crank 62 is easily and smoothly.

The upper roller 111 is composed of a first inner portion 1111 and the first outer portion 1112, and the lower roller 112 is composed of a second inner portion 1121 and the second outer portion 1122.

The gear unit 15 is composed of the start pinion 1521, a first dual-gear 152, a second dual-gear 153, a transmission gear 154, a first passive gear 155 and a second passive gear 156. The first passive gear 155 is connected to the upper roller 111 and engaged with the second passive gear 156 which is connected to the lower roller 112. The first and second passive gears 155, 156 have the same number of teeth and radius so that the upper and lower rollers 111, 112 are co-rotated at the same speed. The gear unit 15 is located between the roller unit frame 13 and the operation handle 6.

The crank 62 is supported by the first and second crank bearings 141, 142, and cooperated with the start pinion 151 to drive the first dual-ear 152 of the gear unit 15 and the second dual-gear 153 is driven. The transmission gear 154 connected with the lower roller 112 and the second passive gear 156 are then driven in sequence. The first passive gear 155 is driven by the first dual-gear 152 and the second passive gear 156 so that the users need only limited force to operate the roller press. In addition, the second ends of the rollers 111, 112 are not restricted by the gear unit 15 and functioned as open type.

The roller unit 11 comprises an upper roller 111 and a lower roller 112. The two respective first ends of the upper roller 111 and the lower roller 112 extend through a first sidewall 131 of a roller unit frame 13 and are connected with the gear unit 15 on outside of the first sidewall 131. Two respective second ends of the upper roller 111 and the lower roller 112 extend through a second sidewall 132 of the roller unit frame 13. The two second ends of the upper roller 111 and the lower roller 112 form a first outer portion 1112. Therefore, an open-type roller press is formed. A first entry 121 is defined between the upper roller 111 and the lower roller 112 between the first and second sidewalls 131, 132. A second entry 122 is defined between the first and second outer portions 1112, 1122 and is co-operated with the first entry 121. The upper roller is supported by first upper bearing 1311 and the second upper bearing 1321, and the lower roller 112 is support by a first lower bearing 1312 and a second lower bearing 1322.

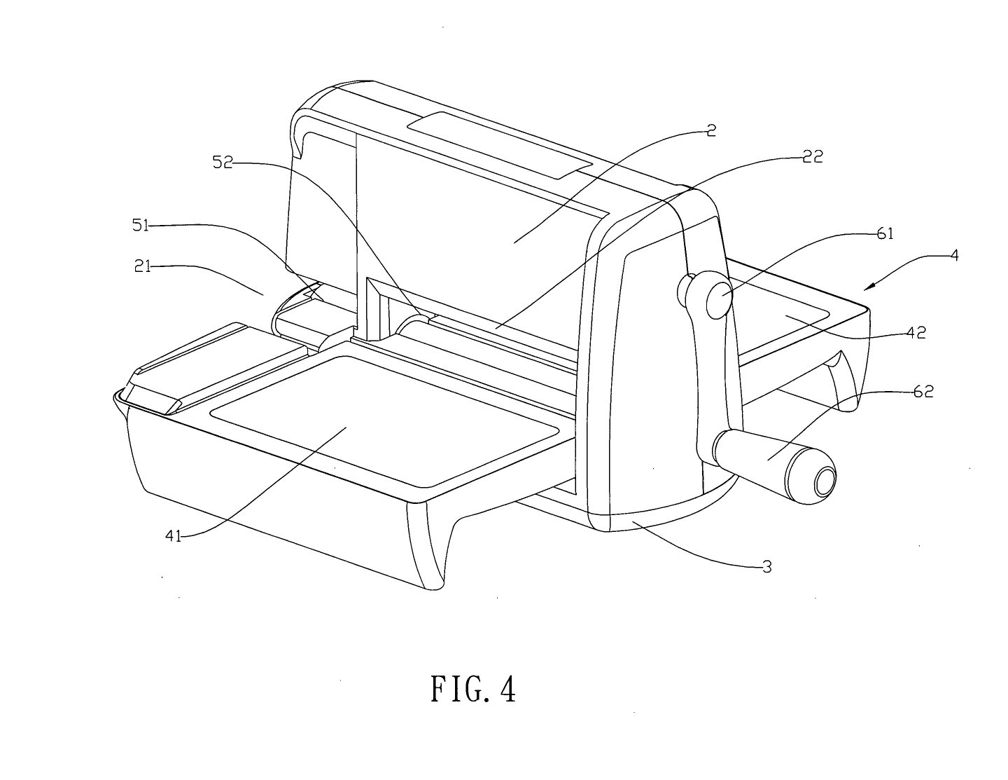

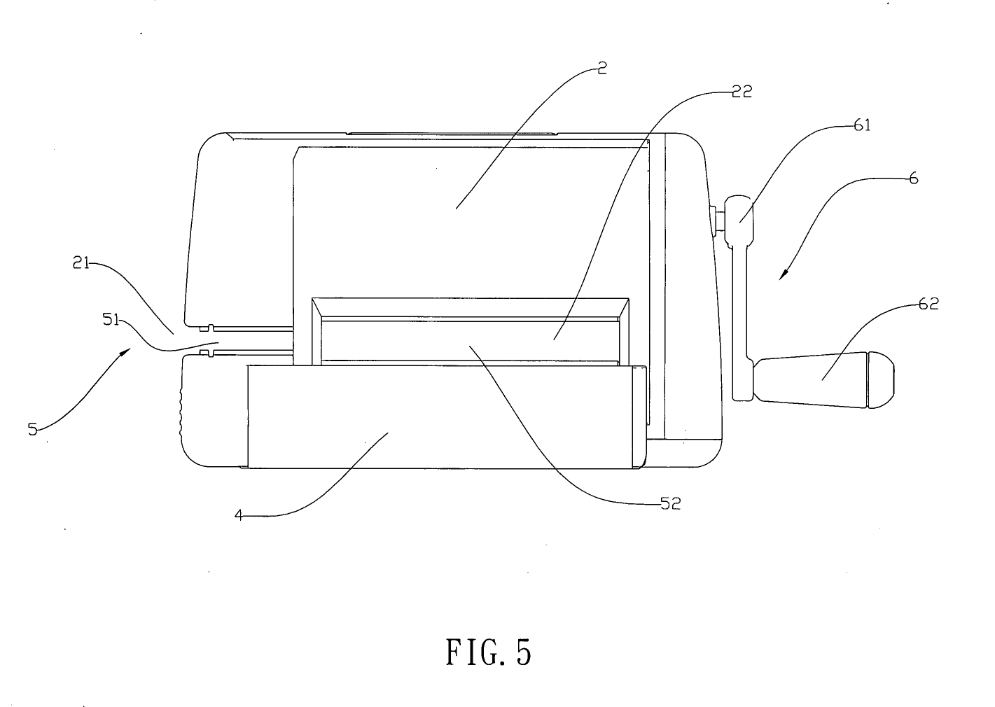

Further referring to FIGS. 4-6, a case 2 is mounted to the dual-roller mechanism 1 and the two entries 21, 22 are defined in the front side and the rear side of the case 2. The two entries 21, 22 are located corresponding to the first entry 121. The two entries are the open-type entry 21 and a close-type entry. A base 3 is located beneath the dual-roller mechanism 1 and fixed to the case 2. A bridge unit 4 including a first bridge and a second bridge 42, which are located on the front side and the rear side of the case 2 and located corresponding to the two entries 21, 22. An object path 5 including a first path 51 and a second path 52 is defined in the roller press, and the first path 51 and the second path 52 are respectively defined by the two entries 21, 22. The first and second paths 51, 52 on the front side and the rear side of the case 2 form a dual-roller path. The second path 52 is an open-type path.

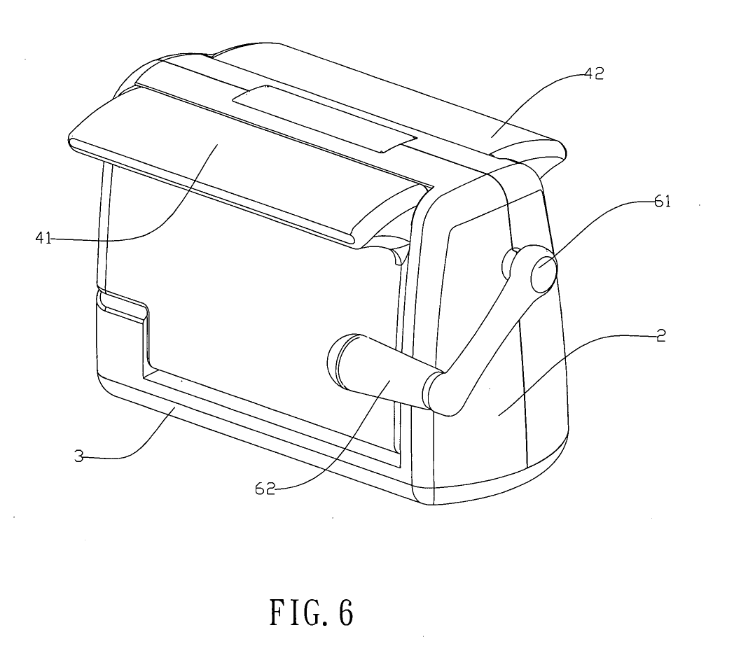

The first and second bridges 41, 42 are designed to support the product to be pressed and can be pivotable upward for convenience of storage as shown in FIG. 6. The upward pivoted bridges 41, 42 seal the first and second paths 51, 52 for safety reason.

While we have shown and described the embodiment in accordance with the present invention, it should be clear to those skilled in the art that further embodiments may be made without departing from the scope of the present invention.

What is claimed is:

1. A roller press comprising:
two rollers (111, 112) each having a first end extending through a first sidewall (131) of a roller unit frame (13) and connected with a gear unit (15) on outside of the first sidewall (131), two respective second ends of the two rollers (111, 112) extending through a second sidewall (132) of the roller unit frame (13), a gap defined between the two rollers (111, 112) to form a dual-roller pressing mechanism (1);
an operation handle (6) having a crank (62) which extends through a first crank bearing (141), a second crank bearing (142) and a shaft (61), a start pinion (151) connected to the shaft (61);
a case (2) mounted to the dual-roller mechanism (1) and two entries (21, 22) defined in a front side and a rear side of the case (2), the two entries (21, 22) located corresponding to the gap, the two entries (21, 22) defining a first path (51) and a second path (52) located at a distance from the gap;
a base (3) located beneath the dual-roller mechanism (1) and fixed to the case (2), and
two bridges (41, 42) located on the front side and the rear side of the case (2) and located corresponding to the two entries (21, 22).

2. The roller press as claimed in claim 1, wherein the two entries are an open-type entry (21) and a close-type entry (22), the two entries are located horizontally and corresponding to a mold entry (12) defined between the two rollers (111, 112), the two entries and the first and second paths (51, 52) on the front side and the rear side of the case (2) form a dual-roller path.

3. The roller press as claimed in claim 1, wherein the second path (52) is an open-type path.

4. The roller press as claimed in claim 1, wherein the gear unit (15) is located between the roller unit frame (13) and the operation handle (6).
